(19) United States
(12) Patent Application Publication
(10) Pub. No.: US 2012/0302658 A1
(43) Pub. Date: Nov. 29, 2012

(54) BLACK ULTRAVIOLET CURABLE INKS

(75) Inventors: Daryl W. Vanbesien, Burlington (CA); Michelle N. Chretién, Mississauga (CA); Barkev Keoshkerian, Thornhill (CA); Jenny Eliyahu, Maple (CA); Naveen Chopra, Oakville (CA); Christopher A. Wagner, Toronto (CA)

(73) Assignee: XEROX CORPORATION, Norwalk, CT (US)

(21) Appl. No.: 13/117,765

(22) Filed: May 27, 2011

(51) Int. Cl. C08F 2/48

(52) U.S. Cl. 522/36; 522/39; 522/64

(57) ABSTRACT

There is provided novel black ultraviolet (UV) curable ink compositions having substantially improved curing properties. The novel ink comprises low levels of carbon black in combination with two or more other colored or non-black pigments which result in a black UV curable gel ink with superior cure compared to conventional all-carbon black loaded UV curable gel inks.

### BACKGROUND

The present embodiments relate to phase change ink compositions characterized by being solid at room temperature and molten at an elevated temperature at which the molten ink is applied to a substrate. These phase change ink compositions can be used for ink jet printing in a variety of applications. Such inks may be referred to as solid inks, hot melt inks, phase change inks and the like. For example, U.S. Pat. No. 4,490,731, the disclosure of which is totally incorporated herein by reference, discloses an apparatus for dispensing phase change ink for printing on a recording medium such as paper. In thermal ink jet printing processes employing hot melt inks, the phase change ink is melted by the heater in the printing apparatus and utilized (jetted) as a liquid in a manner similar to that of conventional thermal ink jet printing. Upon contact with the printing recording medium, the molten ink solidifies rapidly, allowing the colorant to substantially remain on the surface of the recording medium instead of being carried into the recording medium (for example, paper) by capillary action, thereby enabling higher print density than is generally obtained with liquid inks. Advantages of a phase change ink in ink jet printing are thus elimination of potential spillage of the ink during handling, a wide range of print density and quality, minimal paper cockle or distortion, and enablement of indefinite periods of nonprinting without the danger of nozzle clogging, even without capping the nozzles.

Phase change inks are desirable for ink jet printers because they remain in a solid phase at room temperature during shipping, long term storage, and the like. In addition, the problems associated with nozzle clogging as a result of ink evaporation with liquid ink jet inks are largely eliminated, thereby improving the reliability of the ink jet printing. Further, in phase change ink jet printers wherein the ink droplets are applied directly onto the final recording medium (for example, paper, transparency material, and the like), the droplets solidify immediately upon contact with the recording medium, so that migration of ink along the printing medium is prevented and dot quality is improved.

Curable phase change inks were conceived as a means to use conventional phase change ink print process, especially transfix, and deliver an increase in mechanical robustness after curing. The present embodiments are directed to UV curable phase change inks. UV curable inks generally comprise at least one curable monomer, a colorant, wax, gellant, cross-linking agent, and a radiation activated initiator or photoinitiator that initiates polymerization of curable components of the ink. In particular, the curable ink is a ultraviolet (UV) curable liquid or gel ink. The present embodiments provide desirable ink qualities, including superior curing properties compared to conventional curable gel inks and without increasing costs.

UV curable gel inks are known. They are for example disclosed in, for example, U.S. Pat. Nos. 7,153,349, 7,259,275, 7,270,408, 7,271,284, 7,276,614, 7,279,506, 7,279,587, 7,293,868, 7,317,122, 7,323,498, 7,384,463, 7,449,515, 7,459,014, 7,531,582, 7,538,145, 7,541,406, 7,553,011, 7,556,844, 7,559,639, 7,563,489, 7,578,587, 7,625,956, 7,632,546, 7,674,842, 7,681,966, 7,683,102, 7,690,782, 7,691,920, 7,699,922, 7,714,040, 7,754,779, 7,812,064, and 7,820,731, the disclosures of each of which are totally incorporated herein by reference. UV curable gel inks can exhibit desirable characteristics such as improved hardness and scratch-resistance and improved adhesion to various substrates. UV curable gel inks can also exhibit advantages in that dot spread of the ink can be controlled, the ink does not bleed excessively into the substrate, including porous substrates.

For black inks, the colorant of choice is carbon black for its color properties and low cost. However, carbon black presents obstacles for UV curing applications because carbon black absorbs strongly in the UV range of the electromagnetic spectrum where the photoinitiators need to absorb to form initiation radicals. In order to resolve this problem, pigment concentrations may be diluted so that the interference with absorption in the UV range is reduced. This dilution, however, causes its own problems, namely, a loss in color saturation. There is thus a need to produce a black UV curable gel ink that absorbs less in the UV region so that the ink will have much better cure without resorting to diluting pigment concentrations.

### SUMMARY

According to embodiments illustrated herein, there is provided a black ultraviolet curable gel ink comprising: a curable ink carrier comprising at least one of a monomer or oligomer; a photoinitiator; a gellant; a mixture of colorants comprising carbon black pigment, and two or more colored pigments; and one or more optional additives, wherein the ink has a colorimetric value L* of from about 10 to about 30 and colorimetric values a* and b* of from about −4.0 to about +4.0.

In further embodiments, there is provided a black ultraviolet curable gel ink comprising: a curable ink carrier comprising at least one of a monomer or oligomer; a photoinitiator; a gellant; a mixture of colorants comprising carbon black pigment, and two or more colored pigments; and one or more optional additives, wherein the ink has a colorimetric value L* of from about 10 to about 23 and colorimetric values a* and b* of from about −2.0 to about +2.0, and further wherein the gellant is selected from a group consisting of: (a) a polyamide with the general structure:

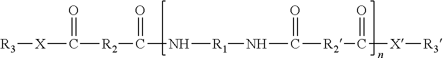

wherein n is an integer between 1 and 5; R₁ is (i) an alkylene group, (ii) an arylene group, (iii) an arylalkylene group (iv) an alkylarylene group; R₂ and R₂′ each, independently of the other, are (i) alkylene groups (ii) arylene groups, (iii) arylalkylene groups (iv) alkylarylene groups; and R₃ and R₃′ each, independently of the other, are either (A) photoinitiating groups, or (B) groups which are (i) alkyl groups, (ii) aryl groups (iii) arylalkyl groups (iv) alkylaryl groups, and X and X′ each, independently of the other, is an oxygen atom or a group of the formula NR₄, wherein R₄ is (i) a hydrogen atom, (ii) an alkyl group, (iii) an aryl group, (iv) an arylalkyl group, or (v) an alkylaryl group; (b) a curable amide gellant; (c) an ester-terminated diamide compound; and (d) a trans-1,2-cyclohexane-bis(urea-urethane) compound.

In yet other embodiments, there is provided a black ultraviolet curable gel ink comprising: a curable ink carrier comprising at least one of a monomer or oligomer; a photoinitiator; a gellant; a mixture of colorants comprising carbon black pigment, and two or more colored pigments selected from the group consisting of cyan, yellow, magenta, blue, orange, violet, red, green and mixtures thereof and mixtures thereof; and one or more optional additives, wherein the ink has a colorimetric value L* of from about 10 to about 30 and colorimetric values a* and b* of from about −4.0 to about +4.0.

### BRIEF DESCRIPTION OF THE DRAWINGS

For a better understanding of the present embodiments, reference may be had to the accompanying figures.

FIG. 1 is a graph illustrating the reflectance curves for the cyan, magenta, and yellow pigments used in the inks of the present embodiments;

FIG. 2A is a graph illustrating the reflectance curve for the orange pigment used in the inks of the present embodiments;

FIG. 2B is a graph illustrating the reflectance curve for the blue pigment used in the inks of the present embodiments; and

FIG. 3 is a graph illustrating double methyl ethyl ketone (MEK) rubs versus cure speed (feet per minute) for inks of the present embodiments.

### DETAILED DESCRIPTION

In the following description, it is understood that other embodiments may be utilized and structural and operational changes may be made without departure from the scope of the present embodiments disclosed herein.

Curable ink technology broadens printing capability and customer base across many markets, and the diversity of printing applications will be facilitated by effective integration of printhead technology, print process and ink materials. As discussed above, while current ink options are successful for printing on various substrates, there are obstacles presented in the use of such ink options. For example, although carbon black is the colorant of choice for black UV curable gel inks, the carbon black causes interference with cure as it absorbs strongly in the UV range of the electromagnetic spectrum where the photoinitiators need to absorb to form initiation radicals. Thus, the present embodiments are directed generally to a novel black UV curable gel ink with substantially improved curing properties.

The embodiments comprise low levels of carbon black in combination with two or more other colored or non-black pigments which result in a black UV curable gel ink with superior cure compared to conventional all-carbon black loaded UV curable gel inks. In embodiments, the amount of carbon black present in the ink is less than about 3 percent by weight of the total weight of the ink. In further embodiments, the amount of carbon black present in the ink is from about 0.1 to about 4 percent or from about 1 to about 3 percent by weight of the total weight of the ink. Pigments are selected such that their absorbance profiles in the visible region of the electromagnetic spectrum combine to absorb at least 95% of the light from about 380 to about 750 nm, or from about 400 to about 700 nm, while absorbing considerably less light from about 250 nm to about 380 nm compared to black pigment, where the photoinitiators absorb. As such, the present embodiments provide an ink that forms a black image with superior cure.

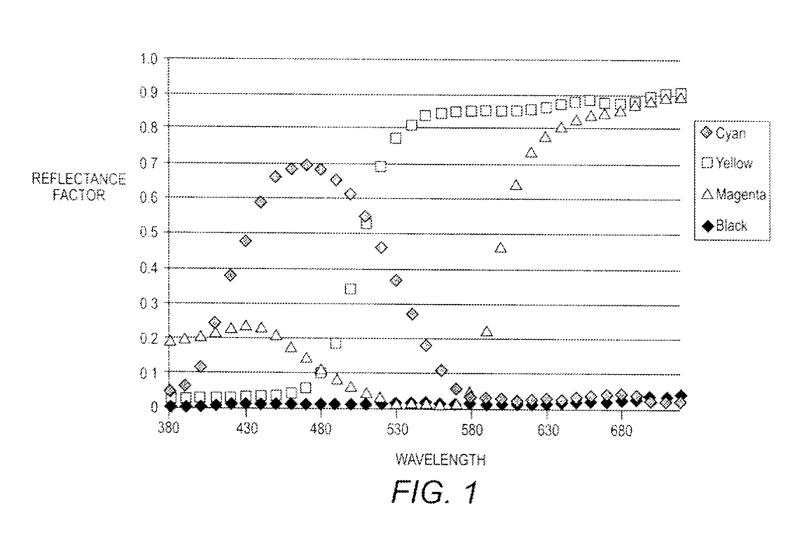

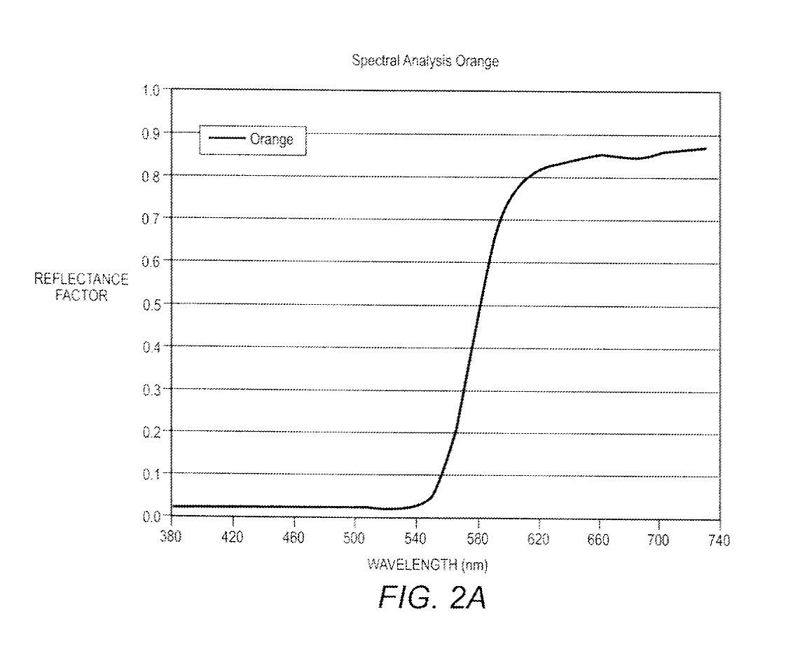

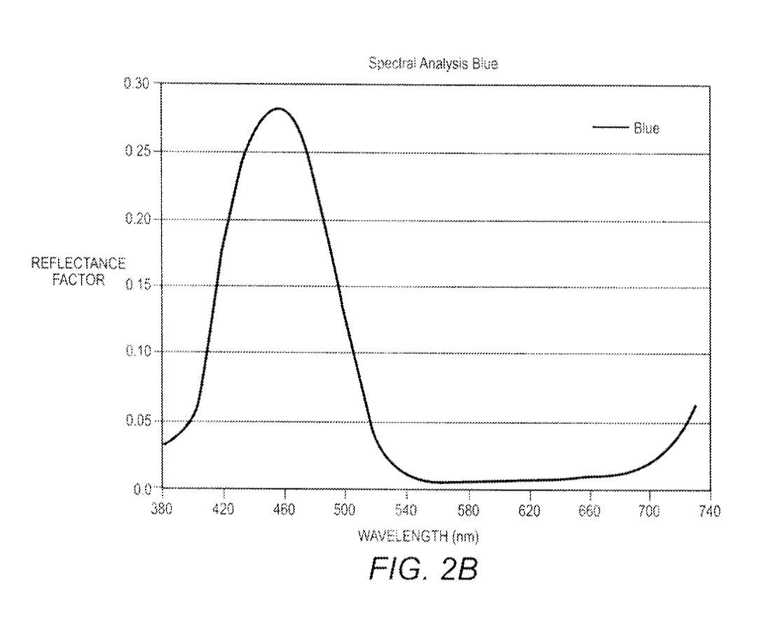

In embodiments, the pigments used in the black UV curable gel ink can be selected from the group consisting of yellow pigments, cyan pigments, magenta pigments, orange pigments, blue pigments, green pigments, violet pigments, red pigments, and mixtures thereof. The reflectance curves for the cyan, magenta, and yellow pigments used in the present embodiments are shown in FIG. 1. As shown, yellow pigment absorbs between 400 and 480 nm, magenta absorbs between 480 and 580 nm, and cyan absorbs between 580 and 700 nm. In one embodiment, the black UV curable gel ink is formed from a mixture of yellow, cyan, magenta and carbon black pigments. The present embodiments can also comprise many different combinations of colored or non-black pigments with carbon black so long as the pigments absorb between 400 and 700 nm. In another embodiment, the black UV curable gel ink is formed from carbon black pigment with an orange pigment, such as Permanent Orange RL 01 (available from Clariant), and a combination of pigments forming Reflex Blue using Spectrapac C (available from Sun Chemical) and Hostaperm Violet BL (available from Clariant) FIGS. 2A and 2B illustrate how the orange pigment absorbs from a range of from about 400 to about 540 nm range while the reflex blue pigments absorbs from a range of from about 540 nm to about 700 nm, respectively.

With the combination of carbon black and two or more other color or non-black pigments, the UV curable gel ink of the present embodiments achieves both a satisfactory black color and also a robust cure superior to conventional black UV curable gel inks. The blackness is primarily measured using a colorimetric value L*, a measurement of color. For example, in embodiments, the L* of the ink is from about 10 to about 30, or from about 10 to about 26, or from about 12 to about 23. The colorimetric values a* and b* are, in embodiments, from about −4.0 to about +4.0, or from about −2.0 to about +2.0, or from about −1.5 to about +1.5.

The ink design of the present embodiments is advantageous over printing a process black using separate cyan, magenta, and yellow inks due to the fact that this approach requires less ink usage and will result in a lower pile height.

Other than the colorant, the UV curable gel ink generally comprises at least one curable monomer, wax, gellant, cross-linking agent, and a radiation activated initiator or photoinitiator.

Gellant

The at least one gellant, or gelling agent, functions at least to increase the viscosity of the ink composition within a desired temperature range. For example, the gellant forms a solid-like gel in the ink composition at temperatures below the gel point of the gellant, for example below the temperature at which the ink composition is applied. For example, the ink composition ranges in viscosity from about 10³ to about 10⁷ cPs, such as from about 10^{3.5} to about 10^{6.5} cPs, in the solid-like phase. The gel phase typically comprises a solid-like phase and a liquid phase in coexistence, wherein the solid-like phase forms a three-dimensional network structure throughout the liquid phase and prevents the liquid phase from flowing at a macroscopic level. The ink composition exhibits a thermally reversible transition between the gel state and the liquid state when the temperature is varied above or below the gel point of the ink composition. This temperature is generally referred to as a sol-gel temperature. This cycle of gel reformation can be repeated a number of times, since the gel is formed by physical, non-covalent interactions between the gelling agent molecules, such as hydrogen bonding, aromatic interactions, ionic bonding, coordination bonding, London dispersion interactions, or the like.

The temperature at which the ink composition is in gel state is, for example, approximately from about 15° C. to about 55° C., such as from about 15° C. to about 50° C. The gel ink composition may liquefy at temperatures of from about 60° C. to about 90° C., such as from about 70° C. to about 85° C. In cooling from the application temperature liquid state to the gel state, the ink composition undergoes a significant viscosity increase. The viscosity increase is at least a three orders of magnitude increase in viscosity, such as at least a four order of magnitude increase in viscosity.

The curable phase change ink composition may include at least one gellant.

The organic gellants function to dramatically increase the viscosity of the ink vehicle and ink composition within a desired temperature range. In particular, the gellant forms a semi-solid gel in the ink vehicle at temperatures below the specific temperature at which the ink composition is jetted. The semi-solid gel phase is a physical gel that exists as a dynamic equilibrium comprised of one or more solid gellant molecules and a liquid solvent. The semi-solid gel phase is a dynamic networked assembly of molecular components held together by non-covalent bonding interactions such as hydrogen bonding, Van der Waals interactions, aromatic non-bonding interactions, ionic or coordination bonding, London dispersion forces, and the like, which upon stimulation by physical forces such as temperature or mechanical agitation or chemical forces such as pH or ionic strength, can reversibly transition from liquid to semi-solid state at the macroscopic level. The ink compositions exhibit a thermally reversible transition between the semi-solid gel state and the liquid state when the temperature is varied above or below the gel-phase transition. This reversible cycle of transitioning between semi-solid gel phase and liquid phase can be repeated many times in the ink formulation. Mixtures of one or more gellants may be used to effect the phase change transition.

The phase change nature of the gellant can thus be used to cause a rapid viscosity increase in the jetted ink composition upon the substrate following jetting of the ink to the substrate. In particular, jetted ink droplets would be pinned into position on a receiving substrate, such as an image-receiving medium (for instance, paper), that is at a temperature cooler than the ink-jetting temperature of the ink composition through the action of a phase change transition in which the ink composition undergoes a significant viscosity change from a liquid state to a gel state (or semi-solid state).

In embodiments, the temperature at which the ink composition forms the gel state is any temperature below the jetting temperature of the ink composition, for example any temperature that is about 10° C. or more below the jetting temperature of the ink composition. There is a rapid and large increase in ink viscosity upon cooling from the jetting temperature at which the ink composition is in a liquid state, to the gel transition temperature, at which the ink composition converts to the gel state.

A suitable gellant for the ink composition would gel the monomers/oligomers in the ink vehicle quickly and reversibly, and demonstrate a narrow phase change transition, for example within a temperature range of about 10° C. to about 85° C. The gel state of exemplary ink compositions should exhibit a minimum of 10^{2.5} mPa·s, such as 10³ mPa·s, increase in viscosity at substrate temperatures, for instance, from about 30° C. to about 60° C., compared to the viscosity at the jetting temperature. In particular embodiments, the gellant-containing ink compositions rapidly increase in viscosity within 5° C. to 10° C. below the jetting temperature and ultimately reach a viscosity above 10⁴ times the jetting viscosity, for example about 10⁶ times the jetting viscosity.

Gellants suitable for use in the ink compositions include a curable gellant comprised of a curable amide, a curable polyamide-epoxy acrylate component and a polyamide component, a curable composite gellant comprised of a curable epoxy resin and a polyamide resin, mixtures thereof and the like, as disclosed in U.S. Patent Publication No. 2010/0304040 A1, which is hereby incorporated herein by reference in its entirety. Inclusion of the gellant in the composition permits the composition to be applied over a substrate, such as on one or more portions of the substrate and/or on one or more portions of an image previously formed on the substrate, without excessive penetration into the substrate because the viscosity of the composition is quickly increased as the composition cools following application. Excessive penetration of a liquid into a porous substrate, such as paper, can lead to an undesirable decrease in the substrate opacity. The curable gellant may also participate in the curing of monomer(s) of the composition.

The gellants suitable for use in the composition may be amphiphilic in nature in order to improve wetting when the composition is utilized over a substrate having silicone or other oil thereon. Amphiphilic refers to molecules that have both polar and non-polar parts of the molecule. For example, the gellants may have long non-polar hydrocarbon chains and polar amide linkages.

Amide gellants suitable for use include those described in U.S. Pat. Nos. 7,531,582, 7,276,614 and 7,279,587, the entire disclosures of which are incorporated herein by reference. Additional gellants suitable for use also include those described in U.S. patent application Ser. No. 12/765,148 to Chopra et al. filed on Apr. 22, 2010.

As described in U.S. Pat. No. 7,279,587, the amide gellant may be a compound of the formula

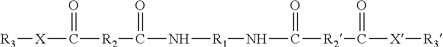

wherein:
R₁ is:
(i) an alkylene group (wherein an alkylene group is a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may or may not be present in the alkylene group) having from about 1 carbon atom to about 12 carbon atoms, such as from about 1 carbon atom to about 8 carbon atoms or from about 1 carbon atom to about 5 carbon atoms,
(ii) an arylene group (wherein an arylene group is a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group) having from about 1 carbon atom to about 15 carbon atoms, such as from about 3 carbon atoms to about 10 carbon atoms or from about 5 carbon atoms to about 8 carbon atoms,
(iii) an arylalkylene group (wherein an arylalkylene group is a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group) having from about 6 carbon atoms to about 32 carbon atoms, such as from about 6 carbon atoms to about 22 carbon atoms or from about 6 carbon atoms to about 12 carbon atoms, or
(iv) an alkylarylene group (wherein an alkylarylene group is a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group) having from about 5 carbon atoms to about 32 carbon atoms, such as from about 6 carbon atoms to about 22 carbon atoms or from about 7 carbon atoms to about 15 carbon atoms,
   wherein the substituents on the substituted alkylene, arylene, arylalkylene, and alkylarylene groups can be halogen atoms, cyano groups, pyridine groups, pyridinium groups, ether groups, aldehyde groups, ketone groups, ester groups, amide groups, carbonyl groups, thiocarbonyl groups, sulfide groups, nitro groups, nitroso groups, acyl groups, azo groups, urethane groups, urea groups, mixtures thereof, and the like, wherein two or more substituents can be joined together to form a ring;

R₂ and R₂′ each, independently of the other, are:
(i) alkylene groups having from about 1 carbon atom to about 54 carbon atoms, such as from about 1 carbon atom to about 48 carbon atoms or from about 1 carbon atom to about 36 carbon atoms,
(ii) arylene groups having from about 5 carbon atoms to about 15 carbon atoms, such as from about 5 carbon atoms to about 13 carbon atoms or from about 5 carbon atoms to about 10 carbon atoms,
(iii) arylalkylene groups having from about 6 carbon atoms to about 32 carbon atoms, such as from about 7 carbon atoms to about 33 carbon atoms or from about 8 carbon atoms to about 15 carbon atoms, or
(iv) alkylarylene groups having from about 6 carbon atoms to about 32 carbon atoms, such as from about 6 carbon atoms to about 22 carbon atoms or from about 7 carbon atoms to about 15 carbon atoms,

wherein the substituents on the substituted alkylene, arylene, arylalkylene, and alkylarylene groups may be halogen atoms, cyano groups, ether groups, aldehyde groups, ketone groups, ester groups, amide groups, carbonyl groups, thiocarbonyl groups, phosphine groups, phosphonium groups, phosphate groups, nitrile groups, mercapto groups, nitro groups, nitroso groups, acyl groups, acid anhydride groups, azide groups, azo groups, cyanato groups, urethane groups, urea groups, mixtures thereof, and the like, and wherein two or more substituents may be joined together to form a ring;

R₃ and R₃′ each, independently of the other, are either:

(a) photoinitiating groups, such as groups derived from 1-(4-(2-hydroxyethoxy)phenyl)-2-hydroxy-2-methylpropan-1-one, of the formula

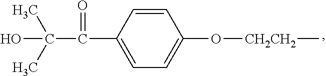

groups derived from 1-hydroxycyclohexylphenylketone, of the formula

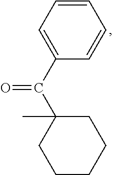

groups derived from 2-hydroxy-2-methyl-1-phenylpropan-1-one, of the formula

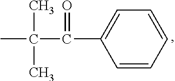

groups derived from N,N-dimethylethanolamine or N,N-dimethylethylenediamine, of the formula

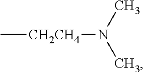

or the like, or:

(b) a group which is:
(i) an alkyl group (including linear and branched, saturated and unsaturated, cyclic and acyclic, and substituted and unsubstituted alkyl groups, and wherein heteroatoms, such as oxygen, nitrogen, sulfur, silicon, phosphorus, boron, and the like either may or may not be present in the alkyl group) having from about 2 carbon atoms to about 100 carbon atoms, such as from about 3 carbon atoms to about 60 carbon atoms or from about 4 carbon atoms to about 30 carbon atoms,
(ii) an aryl group (including substituted and unsubstituted aryl groups, and wherein heteroatoms, such as oxygen, nitrogen, sulfur, silicon, phosphorus, boron, and the like either may or may not be present in the aryl group) having from about 5 carbon atoms to about 100 carbon atoms, such as from about 5 carbon atoms to about 60 carbon atoms or from about 6 carbon atoms to about 30 carbon atoms, such as phenyl or the like,
(iii) an arylalkyl group (including substituted and unsubstituted arylalkyl groups, wherein the alkyl portion of the arylalkyl group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkyl group) having from about 5 carbon atoms to about 100 carbon atoms, such as from about 5 carbon atoms to about 60 carbon atoms or from about 6 carbon atoms to about 30 carbon atoms, such as benzyl or the like, or
(iv) an alkylaryl group (including substituted and unsubstituted alkylaryl groups, wherein the alkyl portion of the alkylaryl group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylaryl group) having from about 5 carbon atoms to about 100 carbon atoms, such as from about 5 carbon atoms to about 60 carbon atoms or from about 6 carbon atoms to about 30 carbon atoms, such as tolyl or the like,

wherein the substituents on the substituted alkyl, arylalkyl, and alkylaryl groups may be halogen atoms, ether groups, aldehyde groups, ketone groups, ester groups, amide groups, carbonyl groups, thiocarbonyl groups, sulfide groups, phosphine groups, phosphonium groups, phosphate groups, nitrile groups, mercapto groups, nitro groups, nitroso groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, and wherein two or more substituents may be joined together to form a ring; and X and X′ each, independently of the other, is an oxygen atom or a group of the formula —NR₄—, wherein R₄ is:

(i) a hydrogen atom;

(ii) an alkyl group, including linear and branched, saturated and unsaturated, cyclic and acyclic, and substituted and unsubstituted alkyl groups, and wherein heteroatoms either may or may not be present in the alkyl group, having from about 5 carbon atoms to about 100 carbon atoms, such as from about 5 carbon atoms to about 60 carbon atoms or from about 6 carbon atoms to about 30 carbon atoms,

(iii) an aryl group, including substituted and unsubstituted aryl groups, and wherein heteroatoms either may or may not be present in the aryl group, having from about 5 carbon atoms to about 100 carbon atoms, such as from about 5 carbon atoms to about 60 carbon atoms or from about 6 carbon atoms to about 30 carbon atoms,

(iv) an arylalkyl group, including substituted and unsubstituted arylalkyl groups, wherein the alkyl portion of the arylalkyl group may be linear or branched, saturated or unsaturated, and cyclic or acyclic, and wherein heteroatoms either may or may not be present in either the aryl or the alkyl portion of the arylalkyl group, having from about 5 carbon atoms to about 100 carbon atoms, such as from about 5 carbon atoms to about 60 carbon atoms or from about 6 carbon atoms to about 30 carbon atoms, or

(v) an alkylaryl group, including substituted and unsubstituted alkylaryl groups, wherein the alkyl portion of the alkylaryl group can be linear or branched, saturated or unsaturated, and cyclic or acyclic, and wherein heteroatoms either may or may not be present in either the aryl or the alkyl portion of the alkylaryl group, having from about 5 carbon atoms to about 100 carbon atoms, such as from about 5 carbon atoms to about 60 carbon atoms or from about 6 carbon atoms to about 30 carbon atoms,

wherein the substituents on the substituted alkyl, aryl, arylalkyl, and alkylaryl groups may be halogen atoms, ether groups, aldehyde groups, ketone groups, ester groups, amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, and wherein two or more substituents may be joined together to form a ring.

Specific suitable substituents and gellants of the above are further set forth in U.S. Pat. Nos. 7,279,587 and 7,276,614, incorporated herein by reference in their entireties, and thus are not further detailed herein.

In embodiments, the gellant may comprise a mixture comprising:

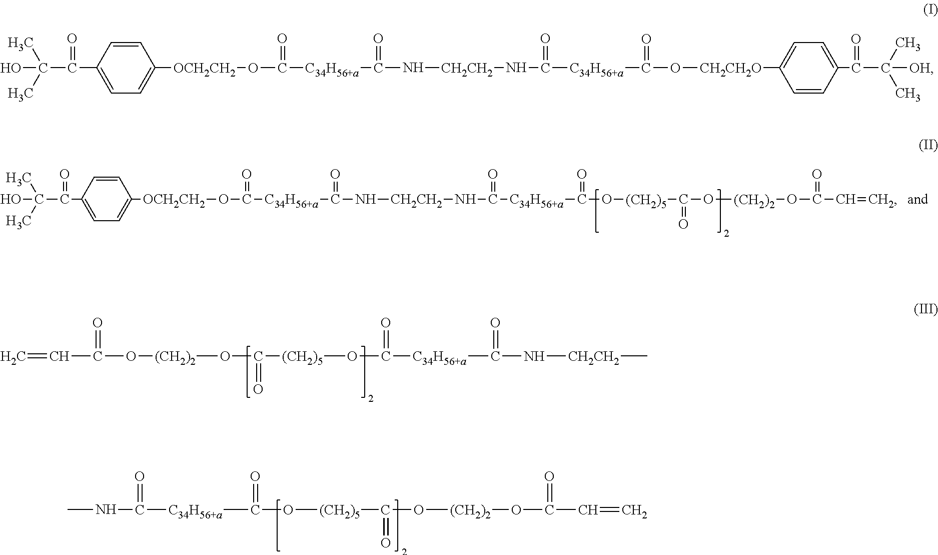

wherein —C₃₄H₅₆₊ₐ— represents a branched alkylene group which may include unsaturations and cyclic groups, wherein the variable “a” is an integer from 0-12.

In embodiments, the gelling agents of the ink may be compounds, as described in U.S. patent application Ser. No. 12/765,148 to Chopra et al., which is hereby incorporated by reference. For example, compounds with the following general structures:

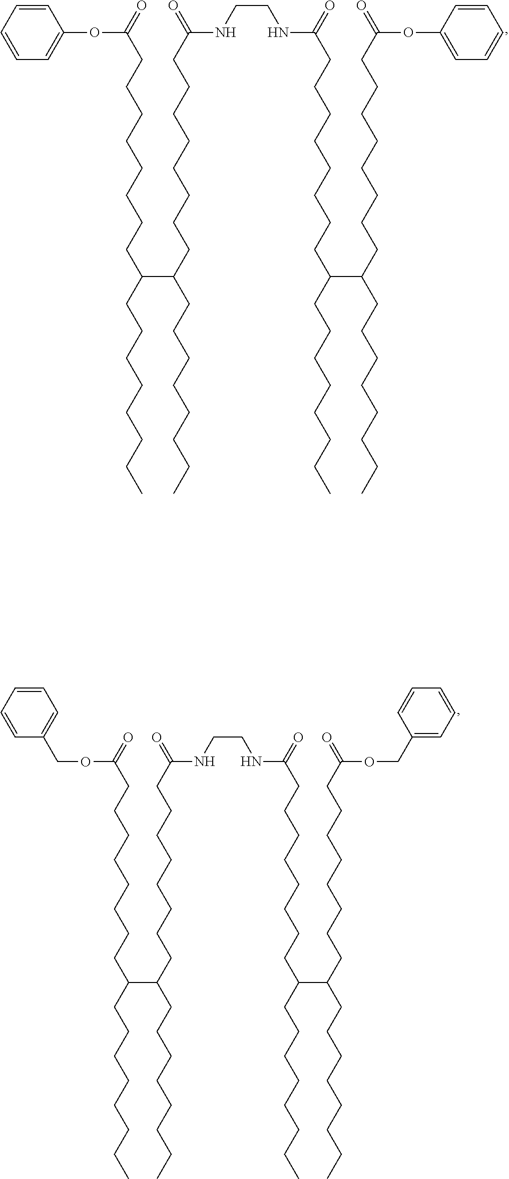

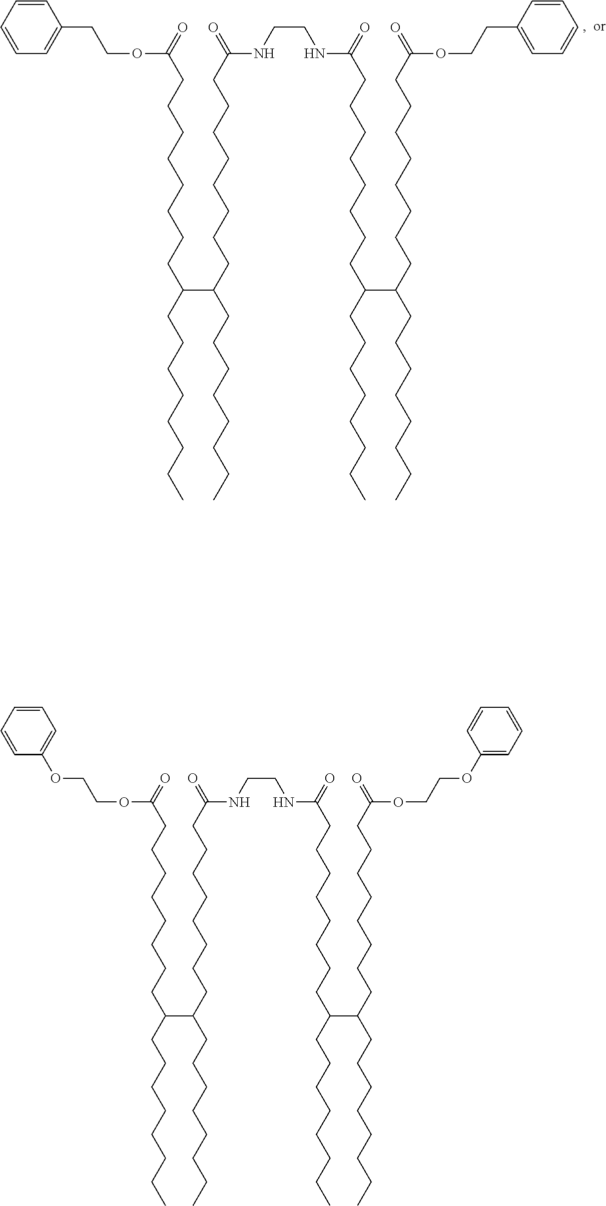

As mentioned above, the ink can include the gelling agent, or gellant, in any suitable amount, such as about 1 percent to about 30 percent by weight of the ink, for example in an amount of about 2 percent to about 20 percent by weight of the ink, such as about 5 percent to about 12 percent by weight of the total ink composition, although the amounts can be outside of these ranges.

The ink composition may include the gellant in any suitable amount, such as about 1 percent to about 50 percent by weight of the ink composition. In embodiments, the gellant may be present in an amount of about 2 percent to about 20 percent by weight of the ink composition, such as about 3 percent to about 10 percent by weight of the ink composition, although the value can also be outside of this range.

Carrier Material

The ink composition also includes a carrier material, or a mixture of two or more carrier materials. For radiation (such as ultraviolet light) curable inks, the curable carrier material is typically a curable monomer, curable oligomer, and the like. The curable carrier may, in embodiments, include one or more of these materials, including mixtures thereof. The curable materials are typically liquid at 25° C. The term “curable” refers, for example, to the component or combination being polymerizable, that is, a material that may be cured via polymerization, including, for example, free radical routes, and/or in which polymerization is photoinitiated though use of a radiation sensitive photoinitiator. Thus, for example, the term “radiation curable” refers is intended to cover all forms of curing upon exposure to a radiation source, including light and heat sources and including in the presence or absence of initiators. Example radiation curing routes include, but are not limited to, curing using ultraviolet (UV) light, for example having, a wavelength of 200-400 nm or more rarely visible light, such as in the presence of photoinitiators and/or sensitizers, curing using e-beam radiation, such as in the absence of photoinitiators, curing using thermal curing in the presence or absence of high temperature thermal initiators (and which are generally largely inactive at the jetting temperature), and appropriate combinations thereof.

Examples of the at least one curable monomer of the ink composition include propoxylated neopentyl glycol diacrylate (such as SR-9003 from Sartomer), diethylene glycol diacrylate, triethylene glycol diacrylate, hexanediol diacrylate, dipropyleneglycol diacrylate, tripropylene glycol diacrylate, alkoxylated neopentyl glycol diacrylate, isodecyl acrylate, tridecyl acrylate, isobornyl acrylate, propoxylated trimethylolpropane triacrylate, ethoxylated trimethylolpropane triacrylate, di-trimethylolpropane tetraacrylate, dipentaerythritol pentaacrylate, ethoxylated pentaerythritol tetraacrylate, propoxylated glycerol triacrylate, isobornyl methacrylate, lauryl acrylate, lauryl methacrylate, neopentyl glycol propoxylate methylether monoacrylate, isodecylmethacrylate, caprolactone acrylate, 2-phenoxyethyl acrylate, isooctylacrylate, isooctylmethacrylate, butyl acrylate, mixtures thereof and the like.

The term “curable monomer” is also intended to encompass curable oligomers, which may also be used in the ink composition. Examples of suitable radiation curable oligomers that may be used in the ink compositions have a low viscosity, for example, from about 50 cPs to about 10,000 cPs, such as from about 75 cPs to about 7,500 cPs or from about 100 cPs to about 5,000 cPs at room temperature. Examples of such oligomers may include CN549, CN131, CN131B, CN2285, CN 3100, CN3105, CN132, CN133, CN 132, available from Sartomer Company, Inc., Exeter, Pa., Ebecryl 140, Ebecryl 1140, Ebecryl 40, Ebecryl 3200, Ebecryl 3201, Ebecryl 3212, available from Cytec Industries Inc, Smyrna Ga., PHOTOMER 3660, PHOTOMER 5006F, PHOTOMER 5429, PHOTOMER 5429F, available from Cognis Corporation, Cincinnati, Ohio, LAROMER PO 33F, LAROMER PO 43F, LAROMER PO 94F, LAROMER UO 35D, LAROMER PA 9039V, LAROMER PO 9026V, LAROMER 8996, LAROMER 8765, LAROMER 8986, available from BASF Corporation, Florham Park, N.J., and the like.

In embodiments, the curable monomer includes both a propoxylated neopentyl glycol diacrylate (such as SR-9003 from Sartomer) and a dipentaerythritol pentaacrylate (such as SR399LV from Sartomer). The inclusion of the pentaacrylate is advantageous in providing more functionality, and thus more reactivity, compared to the diacrylate. However, the amount of the pentaacrylate needs to be limited in the ink composition as too much can adversely affect the viscosity of the composition at application temperatures. The pentaacrylate thus makes up 10 percent by weight or less of the composition, such as 0.5 to 5 percent by weight of the composition.

The curable monomer or oligomer in embodiments is included in the ink in an amount of, for example, about 20 to about 90 weight percent of the ink, such as about 30 to about 85 weight percent, or about 40 to about 80 weight percent, although the amount can be outside of these ranges. In embodiments, mixtures of curable monomer optionally with oligomer are selected to have a viscosity at 25° C. of about 1 to about 50 cP, such as about 1 to about 40 cP or about 10 to about 30 cP, although the amount can be outside of these ranges. In one embodiment, the mixture of curable monomer and oligomer has a viscosity at 25° C. of about 20 cP. Also, in some embodiments, it is desired that the curable monomer or oligomer is not a skin irritant, so that uncured ink compositions are not irritable to users.

Initiator

The ink composition may further include at least one photoinitiator for initiating curing, for example UV curing. Any photoinitiator that absorbs radiation, for example UV light radiation, to initiate curing of the curable components of the formulation may be used, although it is desirable if the photoinitiator does not substantially produce a yellow coloration upon cure.

Examples of free-radical photoinitiators, suitable for use with compositions including acrylates, include benzophenones, benzoin ethers, benzyl ketals, α-hydroxyalkylphenones, and acylphosphine photoinitiators, such as sold under the trade designations of IRGACURE and DAROCUR from Ciba. Another suitable photoinitiator for the present embodiments is IRGASTAB UV10 inhibitor also from Ciba. Specific examples of suitable photoinitiators include 2,4,6-trimethylbenzoyldiphenylphosphine oxide (available as BASF LUCIRIN TPO); 2,4,6-trimethylbenzoylethoxyphenylphosphine oxide (available as BASF LUCIRIN TPO-L); bis(2,4,6-trimethylbenzoyl)-phenyl-phosphine oxide (available as Ciba IRGACURE 819) and other acyl phosphines; 2-methyl-1-(4-methylthio)phenyl-2-(4-morphorlinyl)-1-propanone (available as Ciba IRGACURE 907) and 1-(4-(2-hydroxyethoxy)phenyl)-2-hydroxy-2-methylpropan-1-one (available as Ciba IRGACURE 2959); 2-hydroxy-1-(4-(4-(2-hydroxy-2-methylpropionyl)-benzyl)-phenyl)-2-methylpropan-1-one(available as Ciba IRGACURE 127); titanocenes; isopropylthioxanthone (ITX); 1-hydroxy-cyclohexylphenylketone; benzophenone; 2,4,6-trimethylbenzophenone; 4-methylbenzophenone; diphenyl-(2,4,6-trimethylbenzoyl)phosphine oxide; 2,4,6-trimethylbenzoylphenylphosphinic acid ethyl ester; oligo(2-hydroxy-2-methyl-1-(4-(1-methylvinyl)phenyl)propanone); 2-hydroxy-2-methyl-1-phenyl-1-propanone; benzyl-dimethylketal; and mixtures thereof.

An amine synergist, that is, co-initiators that donate a hydrogen atom to a photoinitiator and thereby form a radical species that initiates polymerization (amine synergists can also consume oxygen dissolved in the formulation—as oxygen inhibits free-radical polymerization its consumption increases the speed of polymerization), for example such as ethyl-4-dimethylaminobenzoate and 2-ethylhexyl-4-dimethylaminobenzoate, may also be included.

In embodiments, the photoinitiator package may include at least one alpha-hydroxy ketone photoinitiator and at least one phosphinoyl type photoinitiator(s). One example of the alpha-hydroxy ketone photoinitiator is IRGACURE 127, while one example of the phosphinoyl type photoinitiator is IRGACURE 819, both available from Ciba-Geigy Corp. (Tarrytown, N.Y). The ratio of the alpha-hydroxy ketone photoinitiator to the phosphinoyl type photoinitiator may be, for example, from about 6 to about 1, such as from about 5 to about 1 or from about 4 to about 1.

The initiator can be present in the ink in any desired or effective amount. For example, the total amount of photoinitiator included in the ink composition may be, for example, from about 0.5 to about 15 percent, such as from about 1 to about 10 percent, by weight of the ink composition, although the amount can be outside of these ranges.

Wax

The ink composition also includes at least one curable wax. A wax is solid at room temperature, specifically at 25° C. Inclusion of the wax thus may also promote an increase in viscosity of the ink composition as it cools from the application temperature. Thus, the wax may also assist the gellant in avoiding bleeding of the ink composition through the substrate.

The curable wax may be any wax component that is miscible with the other components and that will polymerize with the curable monomer to form a polymer. The term wax includes, for example, any of the various natural, modified natural, and synthetic materials commonly referred to as waxes.

Suitable examples of curable waxes include, but are not limited to, those waxes that include or are functionalized with curable groups. The curable groups may include, for example, acrylate, methacrylate, alkene, allylic ether, epoxide, oxetane, and the like. These waxes can be synthesized by the reaction of a wax equipped with a transformable functional group, such as carboxylic acid or hydroxyl. The curable waxes described herein may be cured with the disclosed monomer(s).

Suitable examples of hydroxyl-terminated polyethylene waxes that may be functionalized with a curable group include, for example, mixtures of carbon chains with the structure CH₃—(CH₂)ₙ—CH₂OH, where there is a mixture of chain lengths, n, where the average chain length can be in the range of about 16 to about 50, and linear low molecular weight polyethylene, of similar average chain length. Suitable examples of such waxes include, for example, the UNILIN® series of materials such as UNILIN® 350, UNILIN® 425, UNILIN® 550 and UNILIN® 700 with Mₙ approximately equal to 375, 460, 550 and 700 g/mol, respectively. All of these waxes are commercially available from Baker-Petrolite. Guerbet alcohols, characterized as 2,2-dialkyl-1-ethanols, are also suitable compounds. Exemplary Guerbet alcohols include those containing about 16 to about 36 carbons, many of which are commercially available from Jarchem Industries Inc., Newark, N.J. PRIPOL® 2033 as well as other branched isomers that may include unsaturations and cyclic groups, available from Uniqema, New Castle, Del.; further information on C₃₆ dimer diols of this type is disclosed in, for example, “Dimer Acids,” Kirk-Othmer Encyclopedia of Chemical Technology, Vol. 8, 4^{th} Ed. (1992), pp. 223 to 237, the disclosure of which is totally incorporated herein by reference) may also be used. These alcohols can be reacted with carboxylic acids equipped with UV curable moieties to form reactive esters. Examples of these acids include acrylic and methacrylic acids, available from Sigma-Aldrich Co.

Suitable examples of carboxylic acid-terminated polyethylene waxes that may be functionalized with a curable group include mixtures of carbon chains with the structure CH₃—(CH₂)ₙ—COOH, where there is a mixture of chain) lengths, n, where the average chain length is about 16 to about 50, and linear low molecular weight polyethylene, of similar average chain length. Suitable examples of such waxes include, but are not limited to, UNICID® 350, UNICID® 425, UNICID® 550 and UNICID® 700 with Mₙ equal to approximately 390, 475, 565 and 720 g/mol, respectively. Other suitable waxes have a structure CH₃—(CH₂)ₙ—COOH, such as hexadecanoic or palmitic acid with n=14, heptadecanoic or margaric or daturic acid with n=15, octadecanoic or stearic acid with n=16, eicosanoic or arachidic acid with n=18, docosanoic or behenic acid with n=20, tetracosanoic or lignoceric acid with n=22, hexacosanoic or cerotic acid with n=24, heptacosanoic or carboceric acid with n=25, octacosanoic or montanic acid with n=26, triacontanoic or melissic acid with n=28, dotriacontanoic or lacceroic acid with n=30, tritriacontanoic or ceromelissic or psyllic acid, with n=31, tetratriacontanoic or geddic acid with n=32, pentatriacontanoic or ceroplastic acid with n=33. Guerbet acids, characterized as 2,2-dialkyl ethanoic acids, are also suitable compounds. Exemplary Guerbet acids include those containing 16 to 36 carbons, many of which are commercially available from Jarchem Industries Inc., Newark, N.J. PRIPOL® 1009 as well as other branched isomers that may include unsaturations and cyclic groups, available from Uniqema, New Castle, Del.; further information on C₃₆ dimer acids of this type is disclosed in, for example, “Dimer Acids,” Kirk-Othmer Encyclopedia of Chemical Technology, Vol. 8, 4^{th} Ed. (1992), pp. 223 to 237, the disclosure of which is totally incorporated herein by reference) can also be used. These carboxylic acids can be reacted with alcohols equipped with UV curable moieties to form reactive esters. Examples of these alcohols include, but are not limited to, 2-allyloxyethanol from Sigma-Aldrich Co.; SR495B from Sartomer Company, Inc.; and CD572 (R═H, n=10) and SR604 (R=Me (methyl), n=4) from Sartomer Company, Inc.

The curable wax can be included in the ink composition in an amount of from, for example, about 0.1 percent to about 30 percent by weight of the ink composition, such as from about 0.5 percent to about 20 percent or from about 0.5 percent to 15 percent by weight of the ink composition.

Black Colorants

Suitable black colorants for use in the ink according to the present disclosure include, without limitation, PALIOGEN Black L0084 (commercially available from BASF); Pigment Black K801 (commercially available from BASF); and carbon blacks such as REGAL 330™ (commercially available from Cabot), Nipex 150 (commercially available from Degusssa) Carbon Black 5250 and Carbon Black 5750 (commercially available from Columbia Chemical), and the like, as well as mixtures thereof.

Colorants

Suitable colorants for use in the ink according to the present disclosure include, without limitation, PALIOGEN Violet 5100 (commercially available from BASF); PALIOGEN Violet 5890 (commercially available from BASF); HELIOGEN Green L8730 (commercially available from BASF); LITHOL Scarlet D3700 (commercially available from BASE); SUNFAST Blue 15:4 (commercially available from Sun Chemical); Hostaperm Blue B2G-D (commercially available from Clariant); Hostaperm Blue B4G (commercially available from Clariant); Permanent Red P-F7RK; Hostaperm Violet BL (commercially available from Clariant); LITHOL Scarlet 4440 (commercially available from BASF); Bon Red C (commercially available from Dominion Color Company); ORACET Pink RE (commercially available from BASF); PALIOGEN Red 3871 K (commercially available from BASF); SUNFAST Blue 15:3 (commercially available from Sun Chemical); PALIOGEN Red 3340 (commercially available from BASF); SUNFAST Carbazole Violet 23 (commercially available from Sun Chemical); LITHOL Fast Scarlet L4300 (commercially available from BASE); SUNBRITE Yellow 17 (commercially available from Sun Chemical); HELIOGEN Blue L6900, L7020 (commercially available from BASF); SUNBRITE Yellow 74 (commercially available from Sun Chemical); SPECTRA PAC C Orange 16 (commercially available from Sun Chemical); HELIOGEN Blue K6902₇, K6910 (commercially available from BASF); SUNFAST Magenta 122 (commercially available from Sun Chemical); HELIOGEN Blue D6840, D7080 (commercially available from BASF); Sudan Blue OS (commercially available from BASE); NEOPEN Blue FF4012 (commercially available from BASF); PV Fast Blue B2GO1 (commercially available from Clariant); IRGALITE Blue BCA (commercially available from BASF); PALIOGEN Blue 6470 (commercially available from BASE); Sudan Orange G (commercially available from Aldrich), Sudan Orange 220 (commercially available from BASF); PALIOGEN Orange 3040 (BASF); PALIOGEN Yellow 152, 1560 (commercially available from BASF); LITHOL Fast Yellow 0991 K (commercially available from BASE); PALIOTOL Yellow 1840 (commercially available from BASF); NOVOPERM Yellow FGL (commercially available from Clariant); Ink Jet Yellow 4G VP2532 (commercially available from Clariant); Toner Yellow HG (commercially available from Clariant); Lumogen Yellow D0790 (commercially available from BASE); Suco-Yellow L1250 (commercially available from BASF); Suco-Yellow D1355 (commercially available from BASF); Suco Fast Yellow D1355, D1351 (commercially available from BASF); HOSTAPERM Pink E 02 (commercially available from Clariant); Hansa Brilliant Yellow 5GX03 (commercially available from Clariant); Permanent Yellow GRL 02 (commercially available from Clariant); Permanent Rubine L6B 05 (commercially available from Clariant); FANAL Pink D4830 (commercially available from BASF); CINQUASIA Magenta (commercially available from DU PONT), and the like.

The amount of colorant can vary over a wide range, for instance, from about 0.1 to about 50 weight percent, or from about 0.2 to about 20 weight percent, and combinations of colorants may be used.

Additional Additives

The ink of the present embodiments may further contain one or more additives for their known purposes. For example, suitable additives include a dispersant, a cross-linking agent, a stabilizer, a viscosity modifier, an antioxidant and the like.

Antioxidant

The ink composition can also optionally contain an antioxidant. The optional antioxidants of the ink compositions protect the images from oxidation and also protect the ink components from oxidation during the heating portion of the ink preparation process. Specific examples of suitable antioxidants include NAUGUARD® series of antioxidants such as NAUGUARD® 445, NAUGUARD® 524, NAUGUARD® 76, and NAUGUARD® 5112 (commercially available from Chemtura Corporation, Philadephia, Pa.), the IRGANOX® series of antioxidants such as IRGANOX® 10310 (commercially available from BASF), and the like. When present, the optional antioxidant can be present in the ink in any desired or effective amount, such as in an amount of from at least about 0.01 to about 20 percent by weight of the ink, such as about 0.1 to about 5 percent by weight of the ink, or from about 1 to about 3 percent by weight of the ink, although the amount can be outside of these ranges.

Viscosity Modifier

The ink composition can also optionally contain a viscosity modifier. In particular embodiments, the viscosity controlling agent may be selected from the group consisting of aliphatic ketones, such as stearone, and the like, polymers such as polystyrene, polymethylmethacrylate, and the like, and thickening agents such as those available from BYK Chemie. When present, the optional viscosity modifier can be present in the ink in any desired or effective amount, such as about 0.1 to about 99 percent by weight of the ink, such as about 1 to about 30 percent by weight of the ink, or about 10 to about 15 percent by weight of the ink, although the amount can be outside of these ranges.

Dispersants

Dispersant may be optionally present in then ink formulation. The role of the dispersant is to further ensure improved dispersion stability of the coated magnetic nanoparticles by stabilizing interactions with the coating material. Suitable dispersants include but not limited to, oleic acid, trioctyl phosphine oxide (TOPO), hexyl phosphonic acid (HPA), polyvinylpyrrolidone (PVP), and combinations thereof. Additional suitable dispersants include beta hydroxy carboxylic acids and their esters containing long linear, cyclic or branched aliphatic chains, such as those having about 5 to about 60 carbons, such as pentyl, hexyl, cyclohexyl, heptyl, octyl, nonyl, decyl, undecyl, and the like; sorbitol esters with long chain aliphatic carboxylic acids such as lauric acid, oleic acid (SPAN® 85), palmitic acid (SPAN® 40), and stearic acid (SPAN® 60); polymeric compounds such as polyvinylpyrrolidone, poly(1-vinylpyrrolidone)-graft-(1-hexadecene), poly(1-vinylpyrrolidone)-graft-(1-triacontene), poly(1 vinylpyrrolidone-co-acrylic acid), and combinations thereof. In embodiments, the dispersant is selected from the group consisting of oleic acid, lauric acid, palmitic acid, stearic acid, trioctyl phosphine oxide, hexyl phosphonic acid, polymeric compounds like polyvinylpyrrolidone, poly(l-vinylpyrrolidone)-graft-(1-hexadecene), poly(1-vinylpyrrolidone)-graft-(1-triacontene), poly(1 vinylpyrrolidone-co-acrylic acid), pentyl, hexyl, cyclohexyl, heptyl, octyl, nonyl, decyl, or undecyl beta-hydroxy carboxylic acid, sorbitol esters with long chain carboxylic acid and combinations thereof. Suitable dispersants also include the SOLSPERSE series from Lubrizol Corp (Wickliffe, Ohio), which comprise sulfonic groups; the EFKA series of dispersants including brand numbers 4340, 4585, 7476, 7496 from BASF; and Byk 2001 or Byk 2155 from Bykchemie.

A suitable amount of dispersant can be selected, such as in an amount of about 0.1 to about 10 weight percent, such as from about 0.2 to about 5 weight percent of the ink weight, although the amount can be outside of these ranges. The choice of particular dispersants or combinations thereof as well as the amounts of each to be used are within the purview of those skilled in the art.

Preparation of Ink

The ink composition of the present disclosure can be prepared by any desired or suitable method. For example, in the case of curable gel UV inks the ink ingredients can be mixed together, followed by heating, typically to a temperature of from about 50° C. to about 100° C., although the temperature can be outside of this range, and stirring until a homogeneous ink composition is obtained, followed by cooling the ink to ambient temperature (typically from about 20° C. to about 25° C.). In the case of liquid ink compositions, the ink ingredients can simply be mixed together with stirring to provide a homogeneous composition, although heating can also be used if desired or necessary to help form the composition. Other methods for making ink compositions are known in the art and will be apparent based on the present disclosure.

Printing of the Ink

The present ink may generally be printed on a suitable substrate such as, without limitation, paper, glass art paper, bond paper, paperboard, Kraft paper, cardboard, semi-synthetic paper or plastic sheets, such as polyester or polyethylene sheets, and the like. These various substrates can be provided in their natural state,) such as uncoated paper, or they can be provided in modified forms, such as coated or treated papers or cardboard, printed papers or cardboard, and the like.

Specific suitable papers include plain papers such as XEROX 4200 papers, XEROX Image Series papers, ruled notebook paper, bond paper, silica coated papers such as Sharp Company silica coated paper, JuJo paper, HAMMERMILL LASERPRINT paper, and the like, glossy coated papers such as XEROX Digital Color Gloss, Sappi Warren Papers LUSTROGLOSS, specialty papers such as Xerox DURAPAPER, and the like.

Further suitable materials may be used, including but not limited to, transparency materials, fabrics, textile products, plastics, polymeric films, inorganic recording mediums such as metals and wood, and the like, transparency materials, fabrics, textile products, plastics, polymeric films, inorganic substrates such as metals and wood, and the like.

The inks described herein are further illustrated in the following examples. All parts and percentages are by weight unless otherwise indicated.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

While the description above refers to particular embodiments, it will be understood that many modifications may be made without departing from the spirit thereof. The accompanying claims are intended to cover such modifications as would fall within the true scope and spirit of embodiments herein.

The presently disclosed embodiments are, therefore, to be considered in all respects as illustrative and not restrictive, the scope of embodiments being indicated by the appended claims rather than the foregoing description. All changes that come within the meaning of and range of equivalency of the claims are intended to be embraced therein.

### EXAMPLES

The examples set forth herein below and are illustrative of different compositions and conditions that can be used in practicing the present embodiments. All proportions are by weight unless otherwise indicated. It will be apparent, however, that the present embodiments can be practiced with many types of compositions and can have many different uses in accordance with the disclosure above and as pointed out hereinafter.

Pigment Dispersion Preparation

Pigment dispersion was prepared as follows. Into a 1 liter Attritor (Union Process) was added 1200 grams stainless steel shots (⅛ inch diameter), 30 grams dry pigment according to Table 1, 18 grams EFKA 4340 dispersant, neat (BASF), and 152 grams SR9003 monomer (Sartomer). The mixture was stirred for 18 hours at 400 RPM, and then discharged into a 200 mL container. The resulting pigment dispersion has a pigment concentration of 15 weight percent.

TABLE 1
Pigment Dispersions

| Pigment Dispersion | Dry Pigment | Supplier |
|---|---|---|
| A | Mogul E | Cabot |
| B | Spectrapac C | Sun Chemical |
| C | Permanent Rubine L5B 01 | Clariant |
| D | Novaperm Yellow P-HG | Clariant |
| E | Permanent Orange RL 01 | Clariant |
| F | Hostaperm Violet BL | Clariant |

### Comparative Example

Ink Preparation

100 grams of black UV curable phase-change ink composition was prepared as follows: To a 250 mL amber glass bottle heated to 90 C was added amide gellant, acrylatedlin 350 wax, SR833S monomer (tricyclodecane dimethanol diacrylate (available from Sartomer; Exton, Pa.)), SR399LV (pentafunctional acrylate ester (available from Sartomer)), IRGACURE 379, 819, and 127 (photoinitiators (available from Ciba Specialty Chemicals; Basel, Switzerland)), and IRGASTAB UV10 (stabilizer (available from Ciba Specialty Chemicals)). The mixture was heated with stirring until the solid components were dissolved. The mixture was heated with stirring for 1 hour to complete the ink base preparation. Finally, a pigment dispersion concentrate in SR9003 (proposylated neopentyl glycol diacrylate (available from Sartomer)) was added, and the mixture was homogenized at 10,000 RPM for 0.5 hours more.

Table 2 provides the composition of ink composition A (“Ink A”) which comprises 3 weight percent of carbon black and is the control ink.

TABLE 2

| Component | Amount (grams) |
|---|---|
| Amide Gellant | 7.5 |
| UNILIN 350 Acrylate | 5.0 |
| SR833S | 54.8 |
| SR399LV (pentafunctional acrylate ester) | 5.0 |
| IRGACURE 379 | 3.0 |
| IRGACURE 819 | 1.0 |
| IRGACURE 127 | 3.5 |
| IRGASTAB UV10 | 0.2 |
| Pigment Dispersion A | 20 |
| TOTAL | 100 |

### Example 2

Ink Preparation

An inventive black UV curable phase-change ink composition was prepared as in the Comparative Example except that different pigments are used in place of the only the carbon black. Table 3 provides the composition of ink composition B (“Ink B”) which comprises 1.5 weight percent of carbon black. 0.5 weight percent of cyan, 0.5 weight percent of magenta, and 0.5 weight percent of yellow).

TABLE 3

| Component | Amount (grams) |
|---|---|
| Amide Gellant | 7.5 |
| UNILIN 350 Acrylate | 5.0 |
| SR833S | 54.9 |
| SR399LV (pentafunctional acrylate ester) | 5.0 |
| IRGACURE 379 | 3.0 |
| IRGACURE 819 | 1.0 |
| IRGACURE 127 | 3.5 |
| IRGASTAB UV10 | 0.2 |
| Pigment Dispersion A | 10 |
| Pigment Dispersion B | 3.3 |
| Pigment Dispersion C | 3.3 |
| Pigment Dispersion D | 3.3 |
| TOTAL | 100 |

### Example 3

### Prophetic Example

Ink Preparation

In this prophetic example, an inventive black UV curable phase-change ink composition is to be prepared as in the Comparative Example except that different pigments are again used in place of the only the carbon black. Table 4 provides the prophetic ink composition C (“Ink C”).

TABLE 4

| Component | Amount (grams) |
|---|---|
| Amide Gellant | 7.5 |
| UNILIN 350 Acrylate | 5.0 |
| SR833S | 54.9 |
| SR399LV (pentafunctional acrylate ester) | 5.0 |
| IRGACURE 379 | 3.0 |
| IRGACURE 819 | 1.0 |
| IRGACURE 127 | 3.5 |
| IRGASTAB UV10 | 0.2 |
| Pigment Dispersion A | 10 |
| Pigment Dispersion B | 3.3 |
| Pigment Dispersion E | 3.3 |
| Pigment Dispersion F | 3.3 |
| TOTAL | 100 |

Test Results

Cure

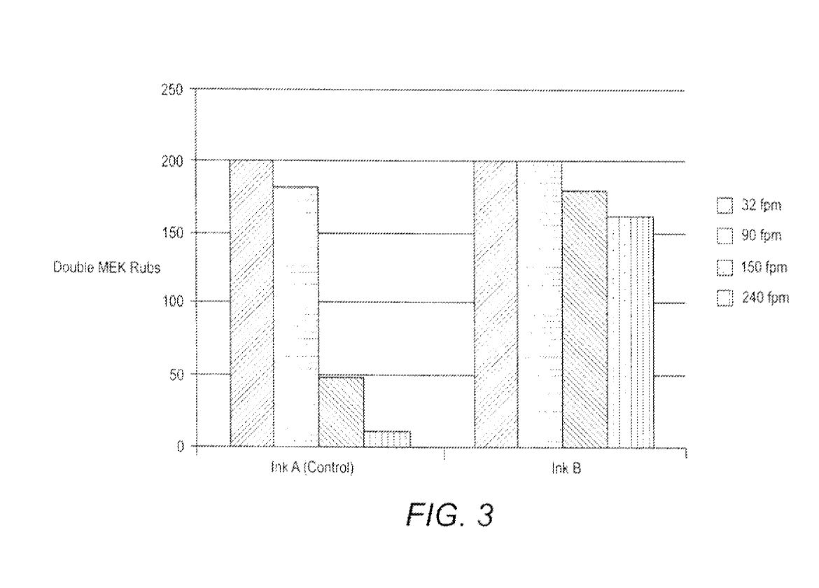

Ink compositions A and B were printed on uncoated MYLAR sheets using a modified printer and cured with a 600W Fusions UV Lighthammer UV curing lamp fitted with a mercury D-bulb under a moving conveyor belt moving at various speeds. The cured films were subjected to methyl ethyl ketone (MEK) double rubs with a cotton swab to evaluate cure. Table 5 and FIG. 3 summarizes the film MEK rub resistance properties.

A good curing ink is considered one in which the MEK double rubs exceed 150 at all speeds. The control ink containing 3 weight percent carbon black fails curing at speeds of 150 feet per minute or faster. As can be seen in Table 5, Ink B containing less black pigment and additional colorants to obtain the black color has far superior cure through all speeds.

TABLE 5

| | 32 fpm | 90 fpm | 150 fpm | 230 fpm |
|---|---|---|---|---|
| Sample | Average | Average | Average | Average |
| Ink A | 200 | 182 | 48 | 10 |
| Ink B | 200 | 200 | 180 | 162 |

Color

Color was measured preparing solid patch prints on DCEG paper, with a resolution of 525×450 and a drop mass of 24 ng. Prints were measured using a Spectrolino spectrophotometer, D50 light source, 2°. The blackness is primarily measured using L*, a measurement of color. The L* of both Inks A and B are shown in Table 6 and are both well-within a satisfactory “black” color. a* and b* values are both between −2 and +2, which is required for black.

TABLE 6

| | L* | a* | b* |
|---|---|---|---|
| Ink A | 18.02 | 0.59 | 0.66 |
| Ink B | 22.11 | 0.7 | −1.09 |

### SUMMARY

In summary, the present embodiments provide an UV curable ink composition comprising low levels of carbon black (as compared to conventional inks) in combination with two or more other colored pigments which result in black ink with superior cure. In particular, the two or more other colored pigments are selected such that their absorbance in the visible region of the electromagnetic spectrum combines to absorb all light, or at least 95% of the light, between 400 to 700 nm with little or no absorption below 300 nm. The present embodiments further provide a print process to form robust cured images, using the ink as described above.

The claims, as originally presented and as they may be amended, encompass variations, alternatives, modifications, improvements, equivalents, and substantial equivalents of the embodiments and teachings disclosed herein, including those that are presently unforeseen or unappreciated, and that, for example, may arise from applicants/patentees and others. Unless specifically recited in a claim, steps or components of claims should not be implied or imported from the specification or any other claims as to any particular order, number, position, size, shape, angle, color, or material.

All the patents and applications referred to herein are hereby specifically, and totally incorporated herein by reference in their entirety in the instant specification

1. A black ultraviolet curable gel ink comprising:
a curable ink carrier comprising at least one of a monomer or oligomer;
a photoinitiator;
a gellant;
a mixture of colorants comprising
carbon black pigment, and
two or more colored pigments, wherein the two or more colored pigments absorb at least 95% of light in a range of from about 400 nm to about 700 nm; and
one or more optional additives, wherein the ink has a colorimetric value L* of from about 10 to about 30 and colorimetric values a* and b* of from about −4.0 to about +4.0.

2. The ink according to claim 1, wherein the two or more colored pigments are selected from the group consisting of cyan, yellow, magenta, blue, orange, violet, red, green and mixtures thereof.

3. The ink according to claim 1 having a colorimetric value L* of from about 10 to about 23 and colorimetric values a* and b* of from about −2.0 to about +2.0.

4. (canceled)

5. The ink according to claim 1 further including a curable wax.

6. The ink according to claim 5, wherein the curable wax is selected from the group consisting of acrylate modified hydroxyl-terminated polyethylene wax, behenyl acrylate, octadecyl acrylate, acrylated C₁₂ linear alcohols, and mixtures thereof.

7. The ink according to claim 1, wherein the curable ink carrier includes one or more monomers selected from the group consisting of propoxylated neopentyl glycol diacrylate, diethylene glycol diacrylate, triethylene glycol diacrylate, hexanediol diacrylate, dipropyleneglycol diacrylate, tripropylene glycol diacrylate, alkoxylated neopentyl glycol diacrylate, isodecyl acrylate, tridecyl acrylate, isobornyl acrylate, propoxylated trimethylolpropane triacrylate, ethoxylated trimethylolpropane triacrylate, di-trimethylolpropane tetraacrylate, dipentaerythritol pentaacrylate, ethoxylated pentaerythritol tetraacrylate, isobornyl methacrylate, lauryl acrylate, lauryl methacrylate, isodecylmethacrylate, propoxylated glycerol triacrylate, lauryl acrylate, neopentyl glycol propoxylate methylether monoacrylate, caprolactone acrylate, 2-phenoxyethyl acrylate, isooctylacrylate, isooctylmethacrylate, butyl acrylate, and mixtures thereof, and wherein the at least one gellant comprises at least one amide gellant.

8. The ink according to claim 1, wherein the photoinitiator is selected from the group consisting of alpha-hydroxy ketones, mono-acyl phosphine oxides, bis-acyl phosphine oxides, and the like, and mixtures thereof.

9. The ink according to claim 1, wherein the gellant is an amide gellant.

10. The ink according to claim 1, wherein the one or more optional additives are selected from the group consisting of a dispersant, a synergist, a stabilizer, a viscosity modifier, an antioxidant, and mixtures thereof.

11. The ink according to claim 1, wherein the carrier is present in an amount of from about 0.1 percent to about 99 percent by weight of the ink.

12. The ink according to claim 1, wherein the mixture of colorants is present in an amount of from about 0.1 percent to about 50 percent by weight of the ink.

13. The ink according to claim 1, wherein the gellant is present in an amount of from about 1 percent to about 30 percent by weight of the ink.

14. A black ultraviolet curable gel ink comprising:
a curable ink carrier comprising at least one of a monomer or oligomer;
a photoinitiator;
a gellant;
a mixture of colorants comprising
carbon black pigment, and
two or more colored pigments, wherein the two or more colored pigments absorb at least 95% of light in a range of from about 400 nm to about 700 nm; and
one or more optional additives, wherein the ink has a colorimetric value L* of from about 10 to about 23 and colorimetric values a* and b* of from about −2.0 to about +2.0, and further wherein the gellant is selected from a group consisting of:
(a) a polyamide with the general structure: 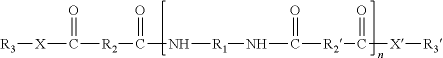
wherein n is an integer between 1 and 5; R₁ is (i) an alkylene group, (ii) an arylene group, (iii) an arylalkylene group (iv) an alkylarylene group;
R₂ and R₂′ each, independently of the other, are (i) alkylene groups (ii) arylene groups, (iii) arylalkylene groups (iv) alkylarylene groups; and R₃ and R₃′ each, independently of the other, are either (A) photoinitiating groups, or (B) groups which are (i) alkyl groups, (ii) aryl groups (iii) arylalkyl groups (iv) alkylaryl groups,
and X and X′ each, independently of the other, is an oxygen atom or a group of the formula NR₄, wherein R₄ is (i) a hydrogen atom, (ii) an alkyl group, (iii) an aryl group, (iv) an arylalkyl group, or (v) an alkylaryl group;
(b) a curable amide gellant;
(c) an ester-terminated diamide compound; and
(d) a trans-1,2-cyclohexane-bis(urea-urethane) compound.

15. The ink according to claim 13, wherein the two or more colored pigments are selected from the group consisting of cyan, yellow, magenta, blue, orange, violet, red, green and mixtures thereof.

16. (canceled)

17. A black ultraviolet curable gel ink comprising:
a curable ink carrier comprising at least one of a monomer or oligomer;
a photoinitiator;
a gellant;
a mixture of colorants comprising
carbon black pigment, and
two or more colored pigments selected from the group consisting of cyan, yellow, magenta, blue, orange, violet, red, green and mixtures thereof, wherein the two or more colored pigments absorb at least 95% of light in a range of from about 400 nm to about 700 nm; and
one or more optional additives, wherein the ink has a colorimetric value L* of from about 10 to about 30 and colorimetric values a* and b* of from about −4.0 to about +4.0.

18. The ink according to claim 17 having a colorimetric value L* of from about 10 to about 23 and colorimetric values a* and b* of from about −2.0 to about +2.0.

19. The ink according to claim 17, wherein the two or more colored pigments absorb at least 95% of light in a range of from about 400 nm to about 700 nm.

20. The ink according to claim 17, wherein the one or more optional additives are selected from the group consisting of a dispersant, a synergist, a stabilizer, a viscosity modifier, an antioxidant, and mixtures thereof.
